(19) United States
(12) Patent Application Publication
(10) Pub. No.: US 2007/0053183 A1
(43) Pub. Date: Mar. 8, 2007

(54) Decorative Illuminant

(76) Inventor: Win Cheng Lai, Lujhu Township (TW)

Correspondence Address: LIN & ASSOCIATES INTELLECTUAL PROPERTY, P.O. BOX 2339, SARATOGA, CA, 95070-0339, US

(21) Appl. No.: 11/220,442

(22) Filed: Sep. 7, 2005

(51) Int. Cl. F21V 9/00

(52) U.S. Cl. 362/231

(57) ABSTRACT

A decorative illuminant includes a decorative body and an illuminant base located at its bottom. The decorative body is made of transparent resin and its interior forms a plurality of refractive spaces that may be irregular cracks or gas bubbles, and the illuminant base is provided with at least one LED. Thus, when light emitted from the LED projects to and pass through the plurality of internal distributed refractive spaces, the light is refracted to spread over random directions to create a bright, colorful, brilliant and beautiful visual effect.

### BACKGROUND OF THE INVENTION

1. Field of the Invention

The present invention relates to a decoration and more particularly to a decoration bringing a brilliant, bright and diversiform light effect by means of light source being projected onto the decoration.

2. The Prior Arts

A conventional decoration provided with light source is generally formed as a body, and the light source works for only auxiliary illumination or setting off the decoration very well; for example, a single color light source is applied to the decoration to bring a distinctive beauty of lighting, but after long-term use, it is hard to avoid causing a visually monotonous and unchangeable impression about the light of beam. Although revolvable glass having several light-transmitted faces with different colors may be applied to some decorations and create various forms when light source is projected onto the glass, it corresponds to only one color of light source at the same time or simply change the color of light so that it is not enough for the variety and hues. In consideration of the poor effects mentioned above, it is desired to provide with a decorative illuminant different from the conventional devices.

### SUMMARY OF THE INVENTION

An objective of the present invention is to provide a decorative illuminant, which can create a colorful, bright and brilliant light effect, and more particularly to provide a decoration, which presents diverse light beams different from a conventional design in the form of decoration only. By means of continuously and repeatedly projecting light to the interior of a body, refracting and diverging, this makes the decoration create a brighter and more brilliant visual light effect.

The secondary objective of the present invention is to provide a vivid and brilliant decorative illuminant. An illuminant base of the present invention comprises a plurality of light-emitting diodes (LED), which may have different colors. A controller provided in the illuminant base is used to control brightness or color of light source so that when the light source projects to the decoration, the refraction of light beams becomes more diverse. If coupling with the special shape of a decorative body, the present invention will become more pleasing. During the variation of light source for example from dark to light or from red to blue, the synchronous variation of the light beams, which is different from a monotonous mode of the conventional devices, presents a special light effect.

In order to achieve the above-mentioned objectives, a decorative illuminant in accordance with the present invention comprises a decorative body and an illuminant base provided at its bottom. The decorative body is made of transparent resin and its interior forms a plurality of refractive spaces that may be irregular cracks or gas bubbles, and the illuminant base is provided with at least one LED. Thus, when light emitted from the LED projects to and passes through the plurality of internal distributed refractive spaces, the light is refracted to spread over random directions to create a bright, colorful, brilliant and beautiful visual effect.

The present invention will become more obvious from the following description when taken in connection with the accompanying drawings, which show, for purposes of illustration only, preferred embodiments in accordance with the present invention.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a decorative illuminant in accordance with a first embodiment of the present invention;

FIG. 2 is a sectional view of the decorative illuminant of the present invention;

FIG. 3 is a side view of a decorative illuminant in accordance with a second embodiment of the present invention; and

FIG. 4 is a side view of a decorative illuminant in accordance with a third embodiment of the present invention.

### DETAILED DESCRIPTION OF THE PREFERRED EMBODIMENT

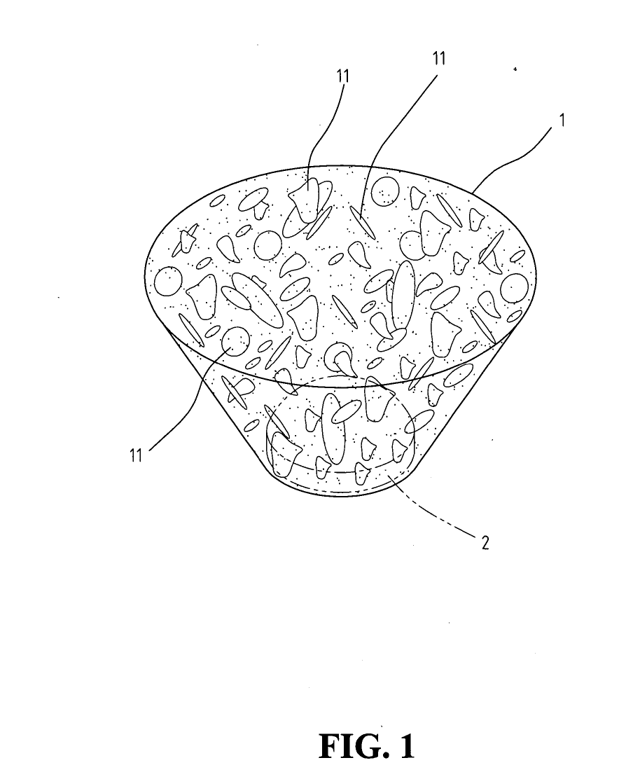

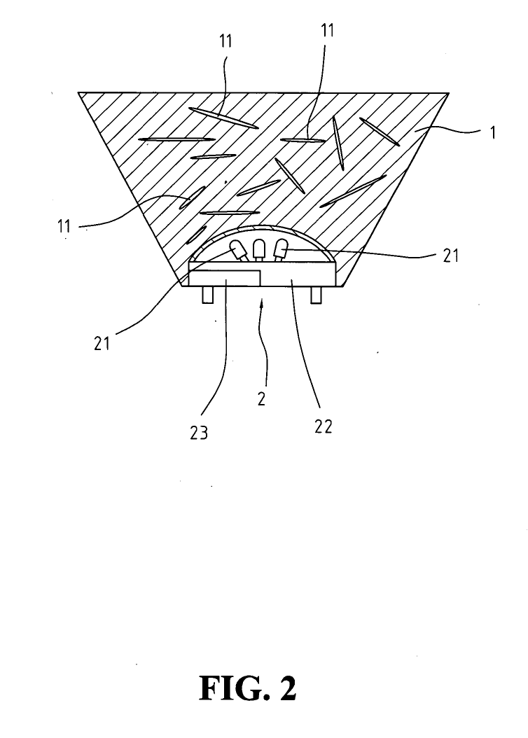

Referring to FIGS. 1 and 2, a decorative illuminant in accordance with a first embodiment of the present invention mainly comprises a decorative body 1 and an illuminant base 2.

The decorative body 1 is made of a transparent material for example resin, which may be shaped into any forms. In this embodiment, it is formed into a cone body gradually contracted from a wide top to a narrow bottom. Further, a plurality of refractive spaces 11 is formed in the form of irregular plane crack and irregularly distributed inside the decorative body 1 (see FIG. 2), which is formed in the process of solidifying and molding the body by means of a special way. Most cracks are different in shape. When the light of a light source projects to the interior of the decorative body 1 and reaches the refractive spaces (cracks) 11, it is refracted to enter into small spaces of the cracks and then into the interior of the decorative body I in repeated, and finally projects outwards so as to present a bright, brilliant and diversiform light effect.

The illuminant base 2 is located at a bottom of the decorative body 1 and may be covered by the decorative body 1, and mainly comprises at least one LED 21, a control circuit board 22 (illustrated with a block in the figure), and a power package 23 provided at the bottom thereof. In this embodiment, the power package 23 is structured from but not limited to a plurality of batteries (illustrated with a block in the figure). The power package 23 may also be an AC power supply. Next, the illuminant base 2 may also comprise a plurality of LEDs 21 with different colors, such as red, blue or green LEDs, or LEDs that may emit multiple colors of light. The control circuit board 22 is used to control the brightness of the LEDs 21. When single color LEDs are used, they may be controlled in a mode from dark to light or in a flash mode, which makes monotonous lights become colorful. If the illuminant base 2 comprises a plurality of LEDs with different colors, the control circuit board 22 controls brightness of each of the LEDs 21 in good time so that the color changes of light are more diverse. Moreover, the light also varies from a single color to a multiple color. When the light is projected to the interior of the decorative body 1, it will create a brighter, more brilliant and more diversiform light effect.

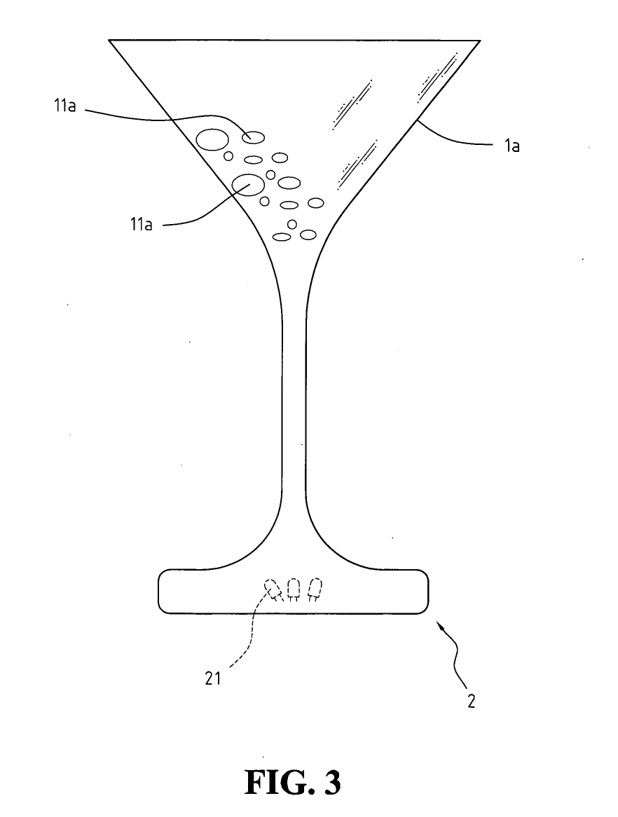

Referring to FIG. 3, which illustrates a decorative illuminant in accordance with a second embodiment of the present invention, the decorative illuminant comprises a decorative body 1a and an illuminant base 2. The decorative body 1a is a goblet body and made of a transparent material for example resin. A plurality of refractive spaces 11a are formed and distributed inside the decorative body 1a. However, in the second embodiment, the refractive spaces 11a are formed in the form of gas bubbles with different size and shape that may be round, oval, or arc. Besides, a transparent and colored thin film is distributed over an inner wall of gas bubbles; namely, colored gas bubbles are distributed inside the decorative body 1a. Furthermore, the refractive spaces (gas bubbles) 11a may be confined to a corner or a specified area (see FIG. 3). When light emitted from LEDs 21 of the illuminant base 2 at the bottom thereof is projected and divergently refracted to a top via a pillar of the goblet, the whole body presents another view of beauty.

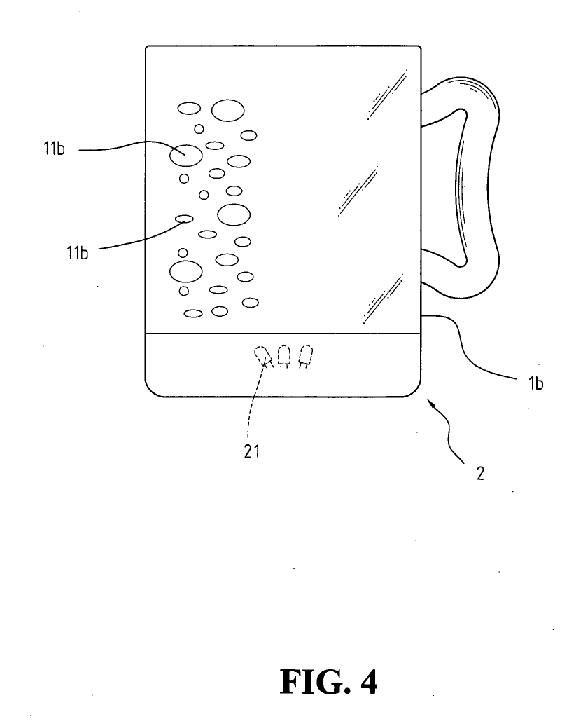

Referring to FIG. 4, which illustrates a decorative illuminant in accordance with a third embodiment of the present invention, the decorative illuminant comprises a decorative body 1b and an illuminant base 2. The decorative body 1b is shaped into a different shape from the second embodiment and its bottom is structured as an illuminant base 2 provided with LEDs 21. The decorative body 1b is in the form of beer mug and a plurality of bubbled and colored refractive spaces 11b are distributed therein. In other words, the decorative body of the present invention is a light-permeable or transparent object that can be designed, depending on users' requests, to different shapes, not being confined to the shape presented in the drawings.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A decorative illuminant, comprising:
a decorative body made of a transparent material, and a plurality of refractive spaces being formed therein; and
an illuminant base comprising at least one light-emitting diode (LED) and provided at a bottom of the decorative body.

2. The decorative illuminant according to claim 1, wherein the decorative body is made of transparent resins.

3. The decorative illuminant according to claim 1, wherein the refractive spaces are formed in the form of cracks and the cracks are randomly distributed over the decorative body.

4. The decorative illuminant according to claim 3, wherein the cracks are irregular plane cracks.

5. The decorative illuminant according to claim 1, wherein the refractive spaces are formed in the form of gas bubbles with irregular shapes and are randomly distributed over the decorative body.

6. The decorative illuminant according to claim 5, wherein a transparent and colored film is distributed over an inner wall of gas bubbles.

7. The decorative illuminant according to claim 1, wherein the illuminant base comprises at least one LED, a control circuit board and a power package.

8. The decorative illuminant according to claim 1, wherein the illuminant base comprises at least one LED being able to emit two or more different colors of light.

9. The decorative illuminant according to claim 1, wherein the illuminant base comprises a plurality of LEDs with different colors.
